(19) United States
(12) Patent Application Publication
(10) Pub. No.: US 2005/0063450 A1
(43) Pub. Date: Mar. 24, 2005

(54) Optical monitoring of thermal barrier coatings

(75) Inventors: Michael Willsch, Furth (DE); Thomas Bosselmann, Marloffstein (DE); Wolfgang Ecke, Jena (DE); Zal Sanjana, Pittsburgh, PA (US)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 10/729,109

(22) Filed: Dec. 5, 2003

Related U.S. Application Data
(60) Provisional application No. 60/505,690, filed on Sep. 24, 2003.

(51) Int. Cl. G01N 17/00; G01N 25/00

(52) U.S. Cl. 374/57; 374/45

(57) ABSTRACT

A system, a method and a component using thermally stimulatable substances for the temperature measurement of thermal barrier coatings are provided. The a thermal barrier coating comprises a stimulatable substance as high-lighter and a substance to adhere the thermal stimulatable substance in the coating. The stimulatable substance having emission lines which vary in response to a temperature of a coated component. For example, the present invention can be used in combustion turbines or combustion machines.

### CROSS REFERENCE TO RELATED APPLICATIONS

This application claims the benefits of the provisional U.S. application 60/505,690 filed Sep. 24, 2003.

### FIELD OF THE INVENTION

The invention generally relates to thermal barrier coatings (TBC), more specifically, the invention relates to thermal barrier coatings (TBC) in hot areas of combustion turbines.

### BACKGROUND OF THE INVENTION

Combustion turbines typically operate at extremely high temperatures, for example, 2500° F. to 2900° F. (1371° C. to 1593° C.). Such high temperatures can cause failure of various components unless they are protected from the heat. These components include the rotating blades of the turbine, and the vanes for directing gas flow within the turbine. A typical turbine will have three to four rows each of blades and vanes, with approximately 30 to 100 blades or vanes per row, and will typically have approximately 500 total blades and vanes to protect. A commonly used material for vanes and blades is superalloys such as nickel-cobalt. Other turbine components exposed to these high temperatures include the combustor and the transition. These high temperature components are generally insulated by a thermal barrier coating so that the turbine can be operated at such high temperatures without causing excessive deterioration of these components. A typical thermal barrier coating (TBC) is yttria stabilized zirconia.

Currently, it is necessary to periodically stop the turbine and inspect the components for deterioration of the thermal barrier coating, defects in other coatings, or other defects, for example, formation of cracks in the underlying components or spalling of the coating. The surface then heats up in the weakened or defected regions, which impairs the superalloy body and causes further spalling of the coating. It would be desirable to monitor the condition of TBC coated components while the turbine is in use. Avoiding the need to periodically stop the turbine for inspection reduces downtime, increases turbine efficiency. Likewise, early detection of defects reduces repair costs and outage time, again increasing turbine efficiency.

An overall monitoring of temperature and strain of the TBC would it make possible to recognize hot spots and mechanical overload. In the past thermocouples and electrical strain gauges were used, which are only single point measurements and the bending of the metal wires limits the use of these sensors only to a few hours. Also pyrotechnical methods are known to determine the temperature on the coating, but these approaches are very costly and not usable for long-term measurements. Furthermore, thermo-cameras which monitor in a small area of the turbine the infrared radiation are known to determine hot spots. But for an overall monitoring a huge amount of cameras is necessary which is very expensive.

Therefore there is a need for a method and apparatus for a low cost overall monitoring thermal barrier coatings.

### SUMMARY OF THE INVENTION

A system, a method and a component using thermally stimulatable substances for monitoring of thermal barrier coatings are provided. Although other systems of monitoring the condition of turbines during use have been proposed, the present invention provides the unique advantage of providing early detection of defects and a means of locating the defect; thereby simplifying the inspection and repair procedure once a defect is identified.

One aspect of the present invention is system for monitoring a thermal barrier coating, comprising: a combustion turbine component coated with a thermal barrier coating, the coating comprising: a thermal stimulatable substance adapted to function as a visual high-lighter, and a mechanism to adhere the thermal stimulatable substance in the coating; a detector to detect removed pieces of the thermal stimulatable substance; and an analyzer to analyze the removed pieces of the thermal stimulatable substance to determine damages of the coating.

Another aspect of the present invention involves a method for monitoring a thermal barrier coating, comprising: providing a thermal stimulatable substance adapted to function as a visual high-lighter; providing a mechanism to adhere the thermal stimulatable substance in the coating; providing a detector to detect removed pieces of the thermal stimulatable substance; and providing an analyzer to analyze the removed pieces of the thermal stimulatable substance to determine damages of the coating.

Another aspect of the present invention involves a component, comprising: a thermal barrier coating with a thermal stimulatable substance adapted to function as a visual high-lighter, and a mechanism to adhere the thermal stimulatable substance in the coating; a detector to detect removed pieces of the thermal stimulatable substance; and an analyzer to analyze the removed pieces of the thermal stimulatable substance to determine the temperature of the coating or damages of the coating.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 is a cross sectional view of an exemplary combustion turbine in which the present invention can be used.

FIG. 2 is a schematic diagram of a coated combustion turbine component with one coating layer.

FIG. 3 is a schematic diagram of a coated combustion turbine component with two coating layers.

FIG. 4 is a schematic diagram of a coated combustion turbine component having a sensing apparatus.

### DESCRIPTION OF THE PREFERRED EMBODIMENTS

One concept of the present invention is the use of thermal stimulatable substances in thermal barrier coatings or in thermal barrier tiles operatively associating to function as high-lighter to determine the temperature of the coating or to determine damages of the coating. Advantageously alkali metal or alkaline earth metal can be used as stimulatable substances, since the emission lines of these substances are narrowband and have a lot of energy. Most of these emission lines are visible. In the context of the present invention high-lighter does not mean a fluorescent marker used to mark important passages of text, but a substance which is more easily visually seen. High-lighters are easy to detect by direct or indirect visual means or mechanisms (e.g. visual recording devices such as cameras). Because the emission lines of alkali metal or alkaline earth substances are recombination lines of atoms and not of molecules, they are stabile to temperature. Fluorescent crystals which are often used in the past do not have this advantageous property. Table 1 shows possible alkali metals or alkaline earth metals and their properties.

TABLE 1
Emision lines of alkali metals or alkaline earth metals

| | Wave | | Wave | | Chemical | | |
|---|---|---|---|---|---|---|---|
| | | | | | compounds and their | | |
| Element | length | Color | length | Color | evaporating temperature | | |
| Li | 610.3 nm | orange | 670.8 nm | red | LiJ, | LiBr, | Lic., |
| | | | | | 1171K | 1300K | 1383K |
| Na | 589.3 nm | yellow | | | NaJ, | NaBr, | NaCl, |
| | | | | | 1304K | 1390K | 1465K |
| K | 404.4 nm | purple | 782.2 nm | infra red | KJ, | KBR, | |
| | | | | | 1323K | 1435K | |
| Rb | 421.0 nm | blue | | | RbJ, | RbBr, | RbCl, |
| | | | | | 1300K | 1340K | 1390K |
| Sr | 661.0 nm | red | | | SrCl₂, | SrL₂, | |
| | | | | | 1250K | 1773K | |
| Ba | 513.7 nm | green | 524.2 nm | green | BaCl₂, | | |
| | | | | | 1560K | | |
| Cu | 535. nm | green | | | CuCl, | CuBr, | CuJ, |
| | | | | | 1400K | 1345K | 1290K |

Another concept of the present invention is the placing of the alkali metal or alkaline earth substances in the thermal barrier coating. The placing is important to avoid the drifting away of the alkali metal or alkaline earth substances out of the thermal barrier coating. For example, the alkali metal or alkaline earth substances can be embedded in small salt crystals or in fine metal powder which will be placed or doped in the thermal barrier coating. The alkali metal or alkaline earth substances can also be put in miniaturized pellets which will be embedded in the coating. This embodiment has the advantage that after the spalling of pieces of the TBC the pellets pass into the gas phase and affect a bright glow which can easily detected. The placing of the alkali metal or alkaline earth substances in the thermal barrier coating can also be accomplished by diffusing the substances into the coating or by applying the substances on the top of the coating, this means an additional coating on the surface of the TBC.

Another concept of the present invention is the detection and monitoring of the high-lighter. The high-lighter can be used to determine the temperature of the coating and the high-lighter can be used to indicate a damaging of the coating. To determine the temperature of the coating the evaporating temperature of the alkali metals or alkaline earth metals (see table 1) can be used. For example, with temperature sensors or optical detectors (cameras, advantageously cameras with interference filters) the temperature of the coating can be determined. To determine damages of the coating a detector 40 and optionally an analyzer 41 and an output device 41 can be used.

The detection of the high-lighter can be accomplished by pictographic inspection with a camera. To separate the high-lighters out of the reverberatory radiation, advantageously color filters (e.g. interference filters) or narrow-band filters, which satisfy the wavelength of the emissions, can be used. An overall measurement requires a lot of cameras or measurement sensors.

Advantageously the detection of peeled off pieces of the thermal barrier coating 26 in the gas stream after the blades 18 can be accomplished with only a few necessary detectors 40 with adequate wide angle optic. With this embodiment all peeled off pieces of the whole turbine 16 can be detected. In this embodiment the measurement doesn't have to be pictographic, but rather can be accomplished by a photo detector, which has to have a sufficient frequency band-width.

Another concept of the present invention is the selective detection of damages of different areas in a combustion turbine 10 or in a turbine 16. Different alkali metal or alkaline earth substances can be embedded in different areas of the turbine in the thermal barrier coating 26a,26b and each individual substance (if it is removed) indicates a damage in this area. For example, in the thermal barrier coatings of each of the different blade rows different alkali metal or alkaline earth substances can be embedded. So a damage of a dedicated blade row can easily determined. Removing a substance out of the TBC comprises: peeling off, breaking off, cracking, detaching.

It is also possible to apply different thermal barrier coatings 26a,26b, each with different alkali metal or alkaline earth substances, on the same component. This enables the detection of a gradual abrasion. This embodiment enables the monitoring of the condition of the thermal barrier coating during maintenance intervals.

Further concepts of the present invention are the use for real-time monitoring and remote monitoring of the thermal barrier coatings 26a,26b of components 30. If a detector 40 detects a substrate which indicates a damage of the coating of a component a analyzing device 41 can localize the damage and the severity of the damage in real-time. The analyzing device can be a Personal Computer as will be understood by those skilled in the art. The analyzer 41 can forward the analyzing-results to one or more output devices 42. The output devices 42 must not be necessarily in the vicinity of the components and the coatings. The connection between the detector 40 and the analyzer 41 or between the analyzer 41 and the output device 42 can be an Internet connection.

A preferred embodiment of the invention is a method and a use for monitoring of the condition of exposed high temperature components within a combustion turbine 10. The invention is particularly useful for monitoring the condition of the thermal barrier coating 26 covering vanes 22 and blades 18 within the turbine or thermal barrier tiles which are often used in combustion machines (e.g. the combustor 14 in a combustion turbine). The significance and functioning of the present invention are best understood through a description of the environment within a combustion turbine 10.

Among others, an advantage of the present invention is that no additional light source for directing an interrogating light beam onto the component 30 is necessary. Therefore the invention is less expensive and can easily mounted, because less devices and less wiring are necessary to implement the invention.

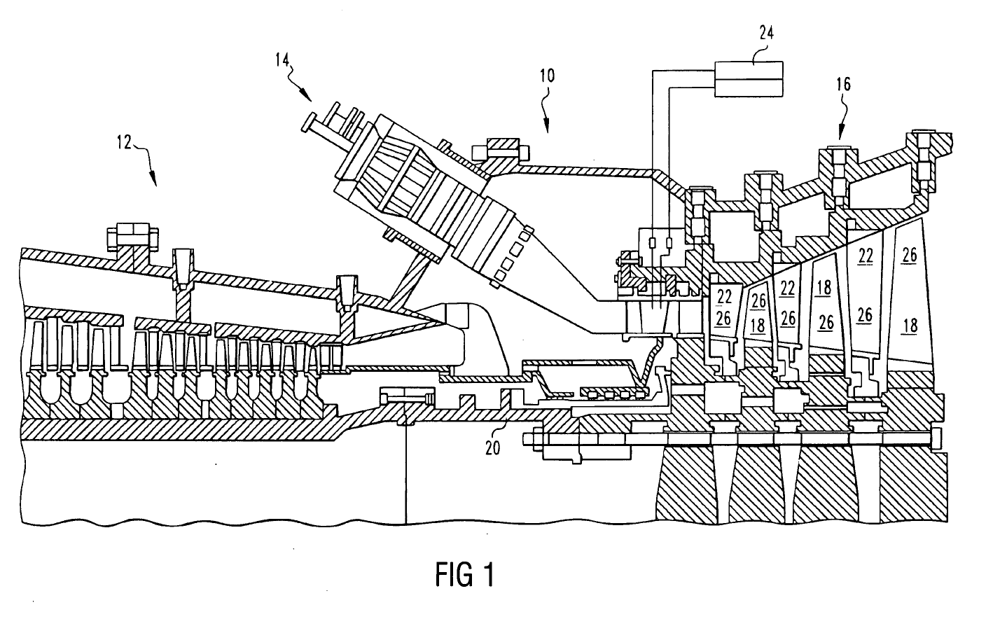

FIG. 1 illustrates a combustion turbine 10. The combustion turbine 10 includes a compressor 12, at least one combustor 14, and a turbine 16. The turbine 16 includes a plurality of rotating blades 18, secured to a rotatable central shaft 20. A plurality of stationary vanes 22 are positioned between the blades 18, with the vanes 22 being dimensioned and configured to guide air over the blades 18. The blades 18 and vanes will typically be made from a superalloy such as nickel-cobalt, and will typically be coated with a thermal barrier coating 26, such as yttria-stabilized zirconia. However, as will be understood by those skilled in the art, the blades and vanes may be made from other materials and may be coated by other materials.

In context of a combustion turbine, in operation, air is drawn in through the compressor 12, where it is compressed and driven towards the combustor 14. The combustor 14 mixes the air with fuel and ignites it, thereby forming a working gas. This working gas will typically be approximately 2500° F. to 2900° F. (1371° C. to 1593° C.). This gas expands through the turbine 16, being guided across the blades 18 by the vanes 22. As the gas passes through the turbine 16, it rotates the blades 18 and shaft 20, thereby transmitting usable mechanical work through the shaft 20. The combustion turbine 10 also includes a cooling system 24, dimensioned and configured to supply a coolant, for example steam or compressed air, to the blades 18 and vanes 22.

From the above description, it becomes apparent that the high temperature corrosive environment wherein the vanes 22 and blades 24 operate is particularly harsh, resulting in serious deterioration of the blades 18 and vanes 22 if the TBC 26 should deteriorate.

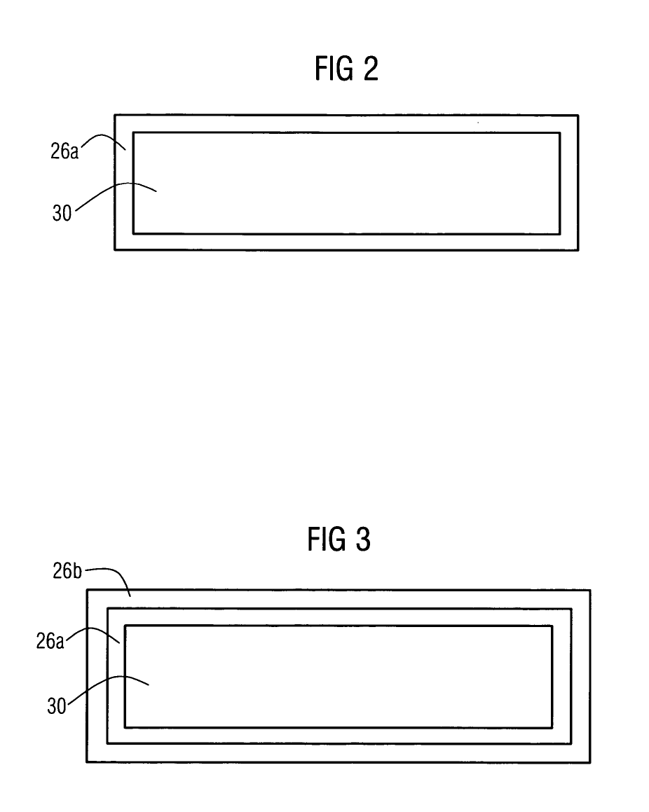

FIG. 2 is a schematic diagram of a coated combustion turbine component 30 with one thermal barrier coating layer 26a. For example, the component 30 can be a turbine blade of a combustion turbine engine or tile in a combustor 14. The invention is applicable to many other types of components to monitor them by operating in hot environments. In this context monitoring means especially determine the temperature or determine damages of the coating. The thermal barrier coating (TBC) can be applied by using known techniques such as chemical vapour deposition (CVD), electron beam physical vapour deposition (EBPVD), plasma spray deposition, electrostatic assisted vapour deposition or any other technique known by those skilled in the art (see, for example, WO97/21848). A thermal barrier coating typically comprises a layer of a refractory or thermally insulating material such as yttria stabilized zirconia or YSZ. The thickness of this layer is typically greater than 100 μm, preferably greater than about 250 μm. Depending on the material of the component 30, a TBC 26a may comprise a plurality of tiers of coating. In one embodiment, three types of coating are used to apply a TBC on a component: First, a bond-coat is applied to provide a good base for the further tiers. The next tier can be an interlayer to provide improved adhesion for the thermally insulating tier. This thermally insulating tier represents the layer with the thermal insulating and structural properties of the TBC. The alkali metal or alkaline earth substances are placed in this final layer. For example, the alkali metal or alkaline earth substances can be embedded in small salt crystals or in fine metal powder which will be placed or doped in the thermal barrier coating. The alkali metal or alkaline earth substances can also be put in miniaturized pellets which will be embedded in the coating. This embodiment has the advantage that after the spalling of pieces of the TBC the pellets pass into the gas phase and affect a bright glow which can easily detected.

FIG. 3 is a schematic diagram of a coated combustion turbine component with two coating layers. The component 30 can be coated by two thermal barrier coatings 26a and 26b. To apply the coatings 26a, 26b the techniques described above can be used. The two coatings can be the same or they can be different. By embedding different alkali metal or alkaline earth substances in each coating the monitoring of the component 30 is more accurate and scalable. This embodiment allows the detection of any gradual abrasion and deterioration of the thermal barrier coating. It is also possible to apply more than two coatings on the component 30. The embodiment with multiple TBC layers and different alkali metal or alkaline earth substances embedded in the layers, especially enables the monitoring of the condition of the thermal barrier coating during maintenance intervals.

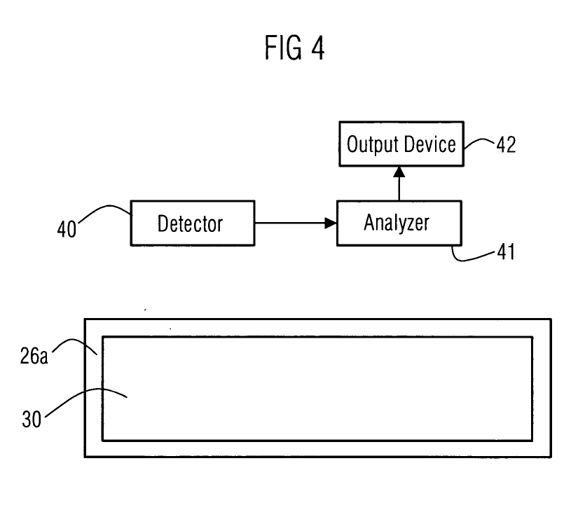

FIG. 4 is a schematic diagram of a coated combustion turbine component having a sensing apparatus 40. The sensing apparatus can be a simple detector (e.g. a camera) that detects pieces which are peeled off out of the TBC 26b. In the TBC alkali metal or alkaline earth substances are embedded, which acts as high-lighters. The peeled off pieces do include the high-lighters which can easily be detected by the camera. To improve the detection, filters can be used to separate the high-lighters out of the reverberatory radiation. Advantageously color filters (e.g. interference filters) or narrow-band filters, which satisfy the wavelength of the emissions, can be used. An overall measurement requires a lot of cameras or measurement sensors 40.

Advantageous embodiments of the present invention are the use for real-time monitoring or remote monitoring of the thermal barrier coating 26a of the component 30. If the detector 40 detects a substrate which indicates a damage of the coating of the component 30, the analyzing device 41 can localize the damage and the severity of the damage in real-time. The analyzing device 41 can be a Personal Computer. The analyzer 41 can forward the analyzed results to one or more output devices 42. The output devices 42 must not be necessarily in the vicinity of the component 30 and the coating 26a. The connection between the detector 40 and the analyzer 41 or between the analyzer 41 and the output device 42 can be an Internet connection. The detector 40 and the analyzer 41 can be integrated in one single device.

Advantageously the output device outputs the temperature and the damages of the coating in a form that is appropriate and convenient for the operating and maintenance staff. For example, colors can be used to display the severity of the damages.

To determine the temperature of the TBC 26a different methods can be applied, depending on the consistency of the thermal barrier coating and the material of the component 30. For example, the temperature of the TBC can be deducted from the evaporation temperature of the alkali metal or alkaline earth substances once, and furthermore the light wavelength of the alkali metal or alkaline earth substances corresponds to atomic lines, which can be determined and from the atomic lines the temperature can be deducted as understood by those skilled in the art.

Among others, an advantage of the present invention is that no additional light source for directing an interrogating light beam onto the component 30 is necessary. Therefore the invention is less expensive and can easily mounted, because less devices and less wiring are necessary to implement the invention.

The present invention is also applicable for monitoring ceramic files or TBC-tiles (tiles coated with TBC or made out of a thermal barrier substance). Advantageously the present invention can be used for tile crack detection. Cracks in TBC can be detected in a way that a thermoluminescent substance escapes from a given cavity by a crack and cause a light effect.

In particular the present invention is applicable to all types of combustion engines and plants with operating temperatures above 1000° C. (1800° F.). Advantageously the present invention is applicable to any ceramic component of a combustion turbine, which is exposed to high temperatures. Furthermore the present invention is applicable to any metal component of a high temperature engine, which is protected by a ceramic coating (TBC). For example, rocket motor components, high performance combustion engines, combustor components, transition pieces (metal or ceramic) of turbines or jet engines used in aviation.

While a specific embodiment of the invention has been described in detail, it will be appreciated by those skilled in the art that various modifications and alternatives to those details could be developed in light of the overall teachings of the disclosure. Also aspects of one or more embodiments can be used or combined with aspects of one or more other embodiments. Accordingly, the particular arrangements disclosed are meant to be illustrative only and not limiting as to the scope of the invention which is to be given the full breadth of the appended claims and any and all equivalents thereof.

1. A system for monitoring a thermal barrier coating, comprising:
a combustion turbine component coated with a thermal barrier coating, the coating comprising:
a thermal stimulatable substance adapted to function as a visual high-lighter, and
a mechanism to adhere the thermal stimulatable substance in the coating;
a detector to detect removed pieces of the thermal stimulatable substance; and
an analyzer to analyze the removed pieces of the thermal stimulatable substance to determine damages of the coating.

2. A system according claim 1, further comprising an output device to output a a damage readable form.

3. A system according claim 1, wherein the component is coated with a plurality of layers of thermal barrier coatings.

4. A system according claim 1, wherein a plurality of components are coated with a thermal barrier coating.

5. A system according claim 4, wherein a plurality of components are coated with thermal barrier coatings, the thermal barrier coating containing different thermal stimulatable substances.

6. A system according to claim 1, wherein the stimulatable substance is an alkali metal or an alkaline earth metal.

7. A system according claim 1, wherein the combustion turbine component is a turbine blade or a turbine vane.

8. A system according claim 1, wherein the combustion turbine component is a combustion engine.

10. A system according claim 1, wherein the combustion turbine component is a heat shield.

11. A method for monitoring a thermal barrier coating, comprising:
providing a thermal stimulatable substance adapted to function as a visual high-lighter;
providing a mechanism to adhere the thermal stimulatable substance in the coating;
providing a detector to detect removed pieces of the thermal stimulatable substance; and
providing an analyzer to analyze the removed pieces of the thermal stimulatable substance to determine damages of the coating.

12. A method according claim 11, further comprising: providing an output device to output a damage readable form.

13. A method according claim 11, further comprising: providing a mechanism for remote monitoring.

14. A method according claim 11, further comprising: providing a mechanism for real-time monitoring.

15. A method according to claim 11, wherein the stimulatable substance is a alkali metal or a alkaline earth metal.

16. A component, comprising:
a thermal barrier coating with a thermal stimulatable substance adapted to function as a visual high-lighter, and a mechanism to adhere the thermal stimulatable substance in the coating;
a detector to detect removed pieces of the thermal stimulatable substance; and
an analyzer to analyze the removed pieces of the thermal stimulatable substance to determine damages of the coating.

17. A component according claim 16, wherein the component is a combustion turbine component.

18. A component according claim 16, wherein the component is coated with a plurality of layers of thermal barrier coatings.

19. A component according claim 16, wherein the thermal barrier coating containing different of thermal stimulatable substances.

20. A combustion turbine component according claim 16, wherein the stimulatable substance is an alkali metal or an alkaline earth metal.

21. A component according claim 16, wherein the component is a metal or ceramic component.
